(19) United States
(12) Patent Application Publication
(10) Pub. No.: US 2025/0253792 A1
(43) Pub. Date: Aug. 7, 2025

(54) METHOD FOR CONTROLLING A POWER CONVERTER USING A VARIABLE SWITCHING FREQUENCY

(71) Applicant: VALEO EAUTOMOTIVE GERMANY GMBH, Erlangen (DE)

(72) Inventor: Marek LEWANDOWSKI, Erlangen (DE)

(73) Assignee: VALEO EAUTOMOTIVE GERMANY GMBH, Erlangen (DE)

(21) Appl. No.: 18/707,369

(22) PCT Filed: Nov. 9, 2022
(86) PCT No.: PCT/EP2022/081366

§ 371 Date: May 3, 2024

(30) Foreign Application Priority Data
Nov. 10, 2021 (DE) 10 2021 212 625.1

(51) Int. Cl. H02P 27/06

(52) U.S. Cl. CPC H02P 27/06

(57) ABSTRACT

A method for controlling a power converter having at least one switching cell and a control unit configured to control the at least one switching cell at a switching frequency such that to deliver an output signal. The method includes regularly adjusting the switching frequency through the control unit such that the switching frequency varies within a period of the output signal. The switching frequency is selected among a set of at least two switching frequencies.

### FIELD OF THE INVENTION

The present invention concerns the field of electric systems controlling the power supply of electric equipment with electric power, in particular configured to be on board an automotive vehicle such as an electric vehicle (EV) or a hybrid vehicle (HV). Such electric systems are designated as power converters.

The present invention relates in particular to a method for controlling a power converter, using a variable switching frequency.

### BACKGROUND OF THE INVENTION

As is known, an electric or a hybrid automotive vehicle presents an electric drive comprising an electric motor and other electrical equipment, such as power converters, which need to be supplied either by a high voltage power supply, or by a low voltage power supply. In this context, power converters are configured to convert an input voltage into an output voltage. For example, an inverter converts a direct current (DC) voltage from a high-voltage power supply battery to an alternating current (AC) electrical power to feed the electric motor to drive the vehicle.

In a general manner, such power converters present switching elements controlled by a control unit according to a switching pattern in order to achieve the wanted output voltage. For example, a conventional method to control the switching elements uses a pulse width modulation (PWM) signal, wherein a switching frequency of the switching elements is kept constant, and the time ratio between the opened and closed states of each switching element, so called duty cycle, is variable.

When establishing the switching pattern, the optimization of switching losses during switching operations and of the current ripple are important challenges to be addressed. The switching losses may induce an overheating of a power stage of the power converter, and thus a decrease of the power converter lifetime. Meanwhile, the switching pattern is required to comply with several constraints such as, among others, the operating capacities of the switching elements and of the control unit, the permissible current ripple, and acoustic and vibration requirements.

In this context, the main objective of the present invention is to provide a method for controlling the power converter and the corresponding power converter, that reduces the switching losses and the current ripple.

### SUMMARY OF THE INVENTION

More precisely, the present invention relates to a method for controlling a power converter having at least one switching cell and a control unit configured to control the at least one switching cell at a switching frequency such that to deliver an output signal. The method further comprises regularly adjusting the switching frequency through the control unit such that the switching frequency varies within a period of the output signal. The switching frequency is selected among a set of at least two switching frequencies.

The switching frequencies of the set of at least two switching frequencies are notably selected in a sorted manner, such that the lower the switching frequency of the set of at least two switching frequencies, the higher the corresponding amplitude range of the output signal. In other words, the method according to the invention allows advantageously to adjust the switching frequency such that to decrease the switching frequency at peaks and valleys of the output signal and to increase the switching frequency around zero-crossings of the output signal. This provides the substantial gain of allowing to reduce the switching losses of the switching elements and/or the current ripple, and thus to increase the lifetime of the inverter.

Moreover, the method according to the invention enables to optimize the switching losses while easing the implementation of a switching pattern of the inverter complying with operating conditions of the control unit and of the switching elements. For instance, the invention makes it possible to keep an average switching frequency, over the period of the output signal, substantially constant and complying with the operating conditions.

According to an embodiment, adjusting the switching frequency through the control unit is performed periodically, each switching frequency of the set of at least two switching frequencies having an associated preset time interval ti, such that the control unit is configured to control the at least one switching cell successively at each switching frequency of the set of at least two switching frequencies for the associated preset time interval ti. This embodiment of the invention presents the advantage of being easily implementable through the control unit, as the adjustment of the switching frequency is arranged in advance.

According to another embodiment, the method comprises the following successive steps:
receiving on a regular basis by the control unit the output signal;
adjusting or keeping the switching frequency through the control unit based on a comparison between a representative value of the output signal and at least one threshold.

This embodiment allows to effectively monitor when it is adequate to adjust the switching frequency.

Advantageously, the set of at least two switching frequencies comprises a first switching frequency and a second switching frequency, the first switching frequency being lower than the second switching frequency. Using two switching frequencies permits to have a more limited number of changes of the switching frequency through the period of the output signal, while still reducing the switching losses.

Advantageously, the at least one threshold having a first threshold, the method comprises:
adjusting the switching frequency to the first switching frequency when the representative value becomes higher than or equal to the first threshold;
adjusting the switching frequency to the second switching frequency when the representative value becomes lower than the first threshold.

Advantageously, the set of at least two switching frequencies further comprises a third switching frequency, the second switching frequency being lower than the third switching frequency. It should be noted that the invention is not limited to a number of three switching frequencies, a higher number of switching frequencies can be considered. The choice of the number of switching frequencies can result from a compromise between on one hand not having to change too frequently the switching frequency through one period of the output signal, and on the other hand reducing the switching losses and/or the current ripple.

Advantageously, the at least one threshold has the first threshold and a second threshold being higher than the first threshold. Then, the method comprises:
adjusting the switching frequency to the first switching frequency when the representative value becomes higher than or equal to the second threshold;
adjusting the switching frequency to the second switching frequency when the representative value becomes higher than or equal to the first threshold and lower than the second threshold;
adjusting the switching frequency to the third switching frequency when the representative value becomes lower than the first threshold.

Advantageously, each of the set of at least two switching frequencies is a multiple of a base switching frequency. Doing so allows to ease the implementation of the method, notably by setting up simple and low-cost operations such as multiplications of integers.

Advantageously, the first switching frequency is equal to the base switching frequency, the second switching frequency is equal to twice the base switching frequency, and the third switching frequency is equal to four times the base switching frequency.

Advantageously, adjusting or keeping the switching frequency through the control unit is performed periodically, preferably at an intermediary switching frequency of the set of at least two switching frequencies.

Advantageously, the output signal is an output current of the power converter. An advantage of using the output current to adjust the switching frequency, is that there is no need for an additional mean for measuring the output current, current setpoint values being directly available.

Advantageously, the method comprises dynamically adjusting the at least one threshold through a regulator circuit of the power converter, such that the average switching frequency of the at least one switching cell over the period of the output signal, is kept substantially constant.

The present invention also concerns the power converter comprising the at least one switching cell and the control unit configured to control the at least one switching cell according to the method as described previously.

According to an aspect of the invention, the power converter is an inverter configured to convert a direct current voltage coming from a high-voltage power supply battery into an alternating current voltage so as to drive an electric motor of an electric drive of an electric vehicle or of a hybrid electric vehicle. The AC voltage may be a multiphase AC voltage, especially a three-phase voltage.

Advantageously, the at least one switching cell has three switching cells such that to supply the electric motor with a three-phase alternating current voltage, the power converter being configured such that adjusting the switching frequency of each one of the three switching cells is performed independently from the other ones of the three switching cells. This allows to reduce the switching losses in an optimized manner for each one of the at least one switching cell.

Another aspect of the invention is the electric drive, comprising the electric motor and the inverter as described above configured to convert a DC voltage into an AC voltage to drive the electric motor.

A further aspect of the invention is the vehicle, comprising the electric drive for driving the vehicle. The vehicle may comprise the high-voltage power supply battery, preferably a rechargeable battery for providing the DC voltage to the inverter, if applicable.

These and other objects, features, aspects and advantages of the present invention will become apparent to those skilled in the art from the following detailed description, which, taken in conjunction with the annexed drawings, discloses preferred embodiments of the present invention.

### BRIEF DESCRIPTION OF THE DRAWINGS

The invention will be better understood on reading the description that follows, and by referring to the appended drawings given as non-limiting examples, in which identical references are given to similar objects and in which:

FIG. 1 is a schematic circuit diagram of an example of an inverter according to an aspect of the invention;

FIG. 2 is a flowchart of a first example of a method for controlling the inverter according to the invention;

FIG. 3 is a flowchart of a second example of the method for controlling the inverter according to the invention;

FIG. 4 is a schematic diagram of an example of an output signal of the inverter and each respective time interval associated to a switching frequency according to an embodiment of the invention;

FIG. 5 is a schematic diagram of another example of the output signal of the inverter and each respective time interval associated to a switching frequency according to another embodiment of the invention;

FIG. 6 is a schematic circuit diagram of an example of a control unit of the inverter according to the invention;

FIG. 7 is a schematic diagram of an automotive electric or hybrid vehicle comprising the inverter according to an aspect of the invention.

### DETAILED DESCRIPTION

Selected embodiments of the present invention will now be explained with reference to the drawings. It will be apparent to those skilled in the art from this disclosure that the following descriptions of the embodiments of the present invention are provided for illustration only and not for the purpose of limiting the invention as defined by the appended claims and their equivalents.

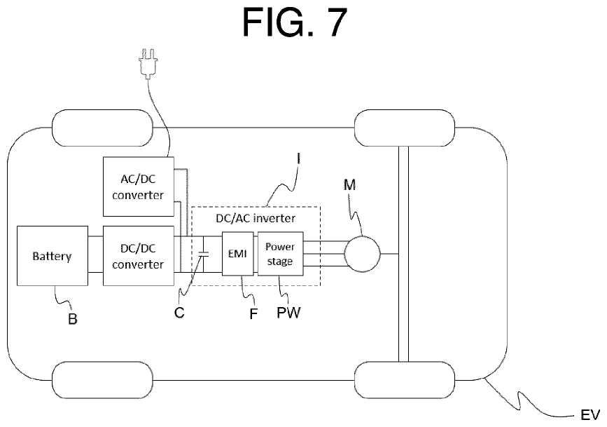

In reference to FIG. 7, an aspect of the invention is an electric vehicle or a hybrid electric automotive vehicle EV comprising wheels and an electric drive configured to drive at least indirectly at least one of the wheels of the vehicle. The vehicle may comprise a high-voltage power supply battery B, preferably a rechargeable battery, for providing electric power to the electric drive.

Another aspect of the invention is the electric drive comprising an electric motor M and an inverter I configured to convert a direct current (DC) voltage coming from the high-voltage power supply battery B into an alternating current (AC) voltage in order to drive the electric motor M. The electric motor M may in particular be a three-phase electric motor. In this context, the inverter I generates three output voltages having a phase shift of 120° between one another.

A further aspect of the invention is the inverter I. The invention is not limited to the previously described application, but may apply to any power converter configured to supply a load with an AC voltage from an electric source. The inverter I especially comprises a power stage PW, an electromagnetic interference (EMI) filtering stage F, an intermediate circuit capacitor C, and electrical conductors forming busbars.

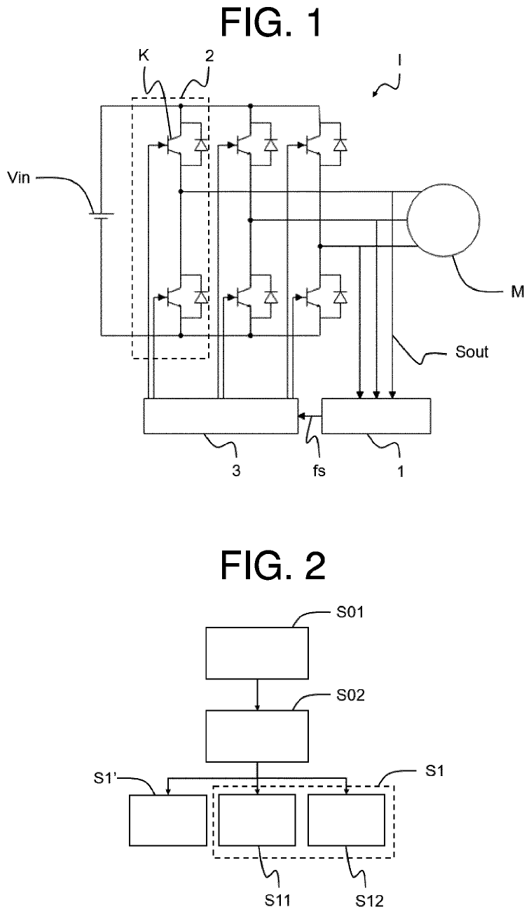

The FIG. 1 illustrates a schematic circuit diagram of an example of inverter I according to the invention. The inverter I comprises at least one switching cell 2 within the power stage, in particular three switching cells, controlled such that to deliver a three-phase AC voltage for driving the electric motor M from the electric source Vin. Each of the three switching cells is then associated to one of the three phases. Each of the at least one switching cell 2 may for instance be arranged in half-bridge configurations having each an upper and a lower switching elements K. The switching elements K may for example be IGBTs or MOSFETs.

The inverter I further comprises a control unit 1 configured to control the at least one switching cell 2 at a switching frequency fs such that to deliver an output signal Sout. In particular, at the switching frequency fs, the at least one switching cell 2 is preferably controlled using a pulse-width modulated (PWM) signal, wherein the time ratio between the opened and closed states of each switching element, so called duty cycle, is variable. The PWM signal may for instance be center-aligned. In that aim, the inverter I may have a PWM generator 3.

According to an aspect on the invention, the present invention relates to a method for controlling the inverter. The method according to this aspect of the invention comprises regularly adjusting the switching frequency fs through the control unit 1 such that the switching frequency fs varies within a period T of the output signal Sout. The output signal Sout may preferably be an output current of the inverter, or alternately an output voltage, an output power, or a combination of those. An advantage of using the output current to adjust the switching frequency, is that there is no need for an additional mean for measuring the output current, current setpoint values being directly available.

The switching frequency fs is further selected among a set of at least two switching frequencies 11, each of the set at least two switching frequencies 11 being different from one another. In other words, the switching frequency is chosen among a discrete number of possible switching frequencies.

In particular, the switching frequency is selected such that the lowest of the set of at least two switching frequencies corresponds to a high amplitude range of the output signal, and the highest of the set of at least two switching frequencies corresponds to a low amplitude range of the output signal. The switching frequencies of the set of at least two switching frequencies are notably selected in a sorted manner, such that the lower the switching frequency of the set of at least two switching frequencies, the higher the corresponding amplitude range of the output signal. Thus, the invention allows to adjust the switching frequency such that to decrease the switching frequency at peaks and valleys of the output signal and to increase the switching frequency around zero-crossings of the output signal. This allows to reduce the switching losses of the switching elements and/or to reduce the current ripple.

More precisely, adjusting the switching frequency to the peaks and valleys of the output current allows to optimize the switching losses. In a similar manner, adjusting the switching frequency to the peaks and valleys of the output voltage allows to optimize the current ripple.

Moreover, the method according to the invention enables to reduce the switching losses while easing the implementation of a switching pattern of the inverter that complies with operating conditions of the control unit and of the switching elements. For instance, each of the set of at least two switching frequencies advantageously respect the minimum and maximum allowable frequencies of the switching elements. In addition, the invention makes it possible to keep an average switching frequency, over the period of the output signal, substantially constant and complying with the operating conditions. The average switching frequency may for instance be preset. Then, the lowest frequency of the set of at least two switching frequencies may be lower than or equal to a lowest desired average switching frequency. Similarly, the highest frequency of the set of at least two switching frequencies may be higher than or equal to a highest desired average switching frequency.

In brief, the invention has the substantial advantage of allowing to adjust the switching frequency among a discrete number of switching frequencies such that to optimize the switching losses and the current ripple, and thus increasing the lifetime of the inverter.

As an example, the set of at least two switching frequencies 11 may comprise a first switching frequency fs1 and a second switching frequency fs2, the first switching frequency fs1 being lower than the second switching frequency fs2. Using two switching frequencies permits to have a more limited number of changes of the switching frequency through the period of the output signal, while still reducing the switching losses.

As another preferred example, the set of at least two switching frequencies 11 comprises the first fs1 and the second fs2 switching frequencies as in the hereabove example, and further comprises a third switching frequency fs3, the second switching frequency fs2 being lower than the third switching frequency fs3. It should be noted that the invention is not limited to a number of three switching frequencies, a higher number of switching frequencies can be considered. The choice of the number of switching frequencies can result from a compromise between on one hand not having to change too frequently the switching frequency through one period of the output signal, and on the other hand reducing the switching losses and/or the current ripple.

Furthermore, each of the set of at least two switching frequencies 11 is preferably a multiple of a base switching frequency fsb. Doing so allows to ease the implementation of the method, notably by setting up simple and low-cost operations such as multiplications of integers. In particular, the base switching frequency is advantageously set up in accordance with hardware, acoustic, thermal, and control speed constraints.

As an example, the first switching frequency fs1 is equal to the base switching frequency fsb, the second switching frequency fs2 is equal to twice the base switching frequency fsb, and the third switching frequency is equal to four times the base switching frequency fsb. For instance, the first, the second, and the third switching frequencies are respectively equal to 4 kHz, 8 kHz, and 16 kHz.

As another example, the first switching frequency fs1 is equal to the base switching frequency fsb, the second switching frequency fs2 is equal to twice the base switching frequency fsb, and the third switching frequency is equal to three times the base switching frequency fsb.

Moreover, the step of adjusting S1 the switching frequency fs of each one of the three switching cells may be performed independently from the other ones of the three switching cells. This allows to reduce the switching losses in an optimized manner for each one of the at least one switching cell. Although, the switching frequency may be aligned between the three switching cells, for example for task synchronization purposes, or for noise and vibration management.

According to an embodiment of the invention, FIG. 4 discloses a diagram of the output signal Sout and the time intervals during which one of the at least one switching cell 2 is controlled at the corresponding switching frequency. Here, a case with three switching frequencies is represented. According to this embodiment of the invention, adjusting S1 the switching frequency fs through the control unit 1 is performed periodically. Each switching frequency of the set of at least two switching frequencies 11 has an associated preset time interval ti, such that the control unit 1 is configured to control the at least one switching cell 2 successively at each switching frequency of the set of at least two switching frequencies 11 for the associated preset time interval ti. In the illustrative example of FIG. 4, each switching frequency fs1, fs2, and fs3 have respectively their associated preset time interval t1, t2, and t3. This embodiment of the invention presents the advantage of being easily implementable through the control unit 1, as the adjustment of the switching frequency is arranged in advance.

According to another embodiment of the invention, adjusting the switching frequency is event-driven, for example after each modulator cycle of the PWM generator 3, or after a measurement of the output signal. This allows to effectively monitor when it is adequate to adjust the switching frequency.

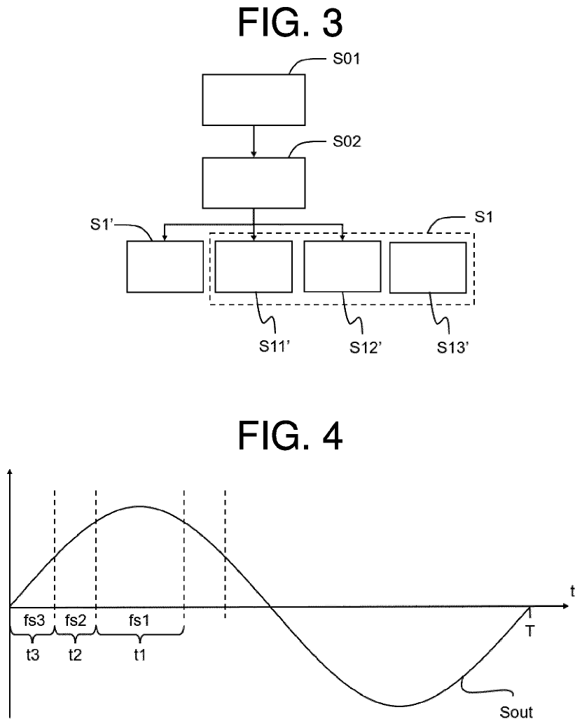

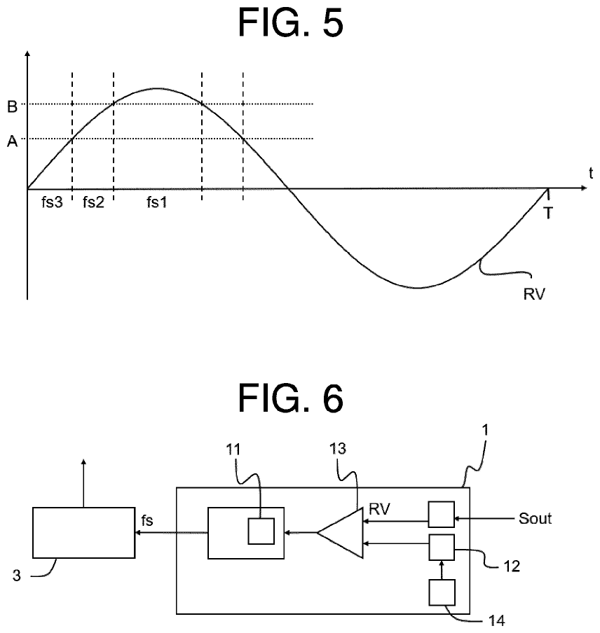

FIG. 5 discloses a diagram of the output signal Sout and the time intervals during which one of the at least one switching cell 2 is controlled at a corresponding switching frequency according to this embodiment of the invention. Here, a particular case with three switching frequencies is represented. FIG. 6 discloses the control unit 1 according to this embodiment of the invention. Then, as represented in FIGS. 2 and 3, the method comprises the following successive steps:
receiving S01 on a regular basis by the control unit 1 the output signal Sout;
adjusting S1 or keeping S1′ the switching frequency fs through the control unit 1 based on a comparison between a representative value RV of the output signal Sout and at least one threshold 12.

Thus, in this embodiment, the switching frequency is directly adapted according to the output signal, which allows to further optimize the switching losses.

Then, the control unit may further comprise a comparison unit 13, as depicted in FIG. 6, configured to compare S02 the representative value RV to the at least one threshold 12 in order to decide whether to adjust S1 or keep S1′ the current value of the switching frequency fs.

Advantageously, the decision of adjusting S1 or keeping S1′ the switching frequency fs through the control unit 1 is performed periodically, preferably at an intermediary switching frequency of the set of at least two switching frequencies, if appropriate.

Furthermore, the representative value RV, to be compared to the at least one threshold 12, may for instance be the absolute value of a normalized output current, meaning the ratio of the absolute value of the phase current setpoint over the magnitude of the current setpoint vector. Then, each of the at least one threshold 12 may be set equal to a preset percentage. Although other parameters may be used for the representative value RV.

The method may further comprise dynamically adjusting the at least one threshold 12 through a regulator circuit 14 of the inverter, as represented in FIG. 6. The at least one threshold 12 may preferably be adjusted such that the average switching frequency fsa of the at least one switching cell 2 over the period T of the output signal Sout, is kept substantially constant. In a more general manner, the at least one threshold 12 may be used to adjust the average switching frequency fsa. Hence, constraints regarding an average switching frequency are easily enforced.

It can be noted that, by adapting the at least one threshold 12, a large range of values for the average switching frequency can be attained, notably between the lowest and the highest switching frequencies of the set of at least two switching frequencies.

The control unit 1 may further comprise one counter for each phase, and a switching frequency controller. After each adjusting step of the switching frequency, the counter is increased by the number of switching events during the time interval of the corresponding switching frequency. Then, the number of switching events is periodically checked by the switching frequency controller to check the adequacy between the counted number of switching events and a wanted average switching frequency, and adjust consequently the at least one threshold to achieve the wanted average switching frequency.

Moreover, the adjustment of the at least one threshold 12 may be performed for the whole power stage, or for each switching cell, independently from the other switching cells.

FIG. 2 discloses a first example of the method according to the embodiment of the invention described hereabove. In this example, the at least one threshold 12 has a first threshold A. Then, the method comprises:
adjusting S11 the switching frequency fs to the first switching frequency fs1 when the representative value RV becomes higher than or equal to the first threshold A,
adjusting S12 the switching frequency fs to the second switching frequency fs2 when the representative value RV becomes lower than the first threshold A.

FIG. 3 discloses a second example of the method according to the embodiment of the invention described previously. In this example, the at least one threshold 12 has the first threshold A and a second threshold B being higher than the first threshold A. Then, the method comprises:
adjusting S11′ the switching frequency fs to the first switching frequency fs1 when the representative value RV becomes higher than or equal to the second threshold B;
adjusting S12′ the switching frequency fs to the second switching frequency fs2 when the representative value RV becomes higher than or equal to the first threshold A and lower than the second threshold B;
adjusting S13′ the switching frequency fs to the third switching frequency fs3 when the representative value RV becomes lower than the first threshold A.

In the second example, the first fs1, the second fs2, and the third fs3 switching frequencies may, as described previously, respectively be equal to 4 kHz, 8 kHz, and 16 kHz. Then, the decision of adjusting S1 or keeping S1′ the switching frequency fs may occur periodically, notably at a frequency of 8 kHz.

In such a case, the phases controlled at the first switching frequency fs1, which corresponds to the slowest switching frequency here equal to 4 kHz, may be operated either for a half-cycle before the next decision, or using a left-aligned PWM for the next cycle after the next decision.

The phases controlled at the second switching frequency fs2, here equal to 8 kHz, are operated for one cycle before the next decision. Finally, the phases controlled at the third switching frequency fs3, here equal to 16 kHz, are operated for two cycles before the next decision.

In both examples, the switching frequencies are adapted gradually such that the higher the value of the output signal, the lower the switching frequency. Thus, for the output signal being the output current, the switching losses are advantageously reduced. The lifetime of the inverter is increased as a consequence. However, another output signal may be used for adjusting the switching frequencies, when aiming to optimize other aspects of the inverter.

In addition, the method may further comprise controlling the inverter at a fixed switching frequency for some periods of time, corresponding to a fixed frequency mode, in addition to controlling the inverter at a variable switching frequency for other periods of time, corresponding to a variable frequency mode. Thus, for specific operations, the inverter may advantageously be controlled at the fixed switching frequency. The variable frequency mode may be performed according to any of the previously described features and embodiments of the invention. To ease the implementation of such a method, the fixed switching frequency may be one of the set of at least two switching frequencies. For the case with three possible switching frequencies, the fixed switching frequency may preferably correspond to the middle switching frequency of the three possible switching frequencies.

Then, a smooth transition may be achieved between the fixed frequency mode and the variable frequency mode, by adjusting the switching pattern. For instance, in the embodiment in which the at least one threshold is used to trigger the adjustment of the switching frequency, the at least one threshold may be gradually adjusted over several periods of the output signal such 5 that to smoothen the transition. The smooth transition presents the advantage of preventing abrupt acoustic and vibration changes.

Although embodiments have been described with reference to a number of illustrative embodiments thereof, it should be understood that other modifications and embodiments can be derived by those skilled in the art that will fall within the scope of the principles of this disclosure.

1. A method for controlling a power converter having at least one switching cell and a control unit configured to control the at least one switching cell at a switching frequency such that to deliver an output signal, wherein the method comprises
regularly adjusting the switching frequency through the control unit such that the switching frequency varies within a period of the output signal, the switching frequency being selected among a set of at least two switching frequencies.

2. The method as claimed in claim 1, wherein adjusting the switching frequency through the control unit is performed periodically, each switching frequency of the set of at least two switching frequencies having an associated preset time interval ti, such that the control unit is configured to control the at least one switching cell successively at each switching frequency of the set of at least two switching frequencies for the associated preset time interval ti.

3. The method as claimed in claim 1, comprising the following successive steps:
receiving on a regular basis by the control unit the output signal;
adjusting or keeping the switching frequency through the control unit based on a comparison between a representative value of the output signal and at least one threshold.

4. The method as claimed in claim 1, wherein the set of at least two switching frequencies comprises a first switching frequency and a second switching frequency, the first switching frequency being lower than the second switching frequency.

5. The method as claimed in claim 4, the at least one threshold having a first threshold, wherein the method comprises:
adjusting the switching frequency to the first switching frequency when the representative value becomes higher than or equal to the first threshold;
adjusting the switching frequency to the second switching frequency when the representative value becomes lower than the first threshold.

6. The method as claimed in claim 4, wherein the set of at least two switching frequencies further comprises a third switching frequency, the second switching frequency being lower than the third switching frequency.

7. The method as claimed in claim 6, the at least one threshold having the first threshold and a second threshold being higher than the first threshold, wherein the method comprises:
adjusting the switching frequency to the first switching frequency when the representative value becomes higher than or equal to the second threshold;
adjusting the switching frequency to the second switching frequency when the representative value becomes higher than or equal to the first threshold and lower than the second threshold;
adjusting the switching frequency to the third switching frequency when the representative value becomes lower than the first threshold.

8. The method as claimed in claim 1, wherein each of the set of at least two switching frequencies is a multiple of a base switching frequency.

9. The method as claimed in the claim 8, wherein the first switching frequency is equal to the base switching frequency, the second switching frequency is equal to twice the base switching frequency, and the third switching frequency is equal to four times the base switching frequency.

10. The method as claimed according to claim 8, wherein adjusting or keeping the switching frequency through the control unit is performed periodically, preferably at an intermediary switching frequency of the set of at least two switching frequencies.

11. The method as claimed in claim 1, wherein the output signal is an output current of the power converter.

12. The method as claimed in claim 1, comprising dynamically adjusting the at least one threshold through a regulator circuit of the power converter, such that an average switching frequency of the at least one switching cell over the period of the output signal, is kept substantially constant.

13. A power converter comprising the at least one switching cell and a control unit configured to control the at least one switching cell according to the method as claimed in claim 1.

14. The power converter as claimed in claim 13 being an inverter configured to convert a direct current voltage coming from a high-voltage power supply battery into an alternating current voltage so as to drive an electric motor.

15. The power converter as claimed in claim 14, wherein the at least one switching cell has three switching cells such that to supply the electric motor with a three-phase alternating current voltage, the power converter being configured such that adjusting the switching frequency of each one of the three switching cells is performed independently from the other ones of the three switching cells.

16. The method as claimed in claim 2, wherein the set of at least two switching frequencies comprises a first switching frequency and a second switching frequency, the first switching frequency being lower than the second switching frequency.

17. The method as claimed in claim 2, wherein each of the set of at least two switching frequencies is a multiple of a base switching frequency.

18. The method as claimed in claim 2, wherein the output signal is an output current of the power converter.

19. The method as claimed in claim 2, comprising dynamically adjusting the at least one threshold through a regulator circuit of the power converter, such that an average switching frequency of the at least one switching cell over the period of the output signal, is kept substantially constant.

20. A power converter comprising the at least one switching cell and a control unit configured to control the at least one switching cell according to the method as claimed in claim 2.
